(19) United States
(12) Patent Application Publication
(10) Pub. No.: US 2021/0277255 A1
(43) Pub. Date: Sep. 9, 2021

(54) ANTI-FRICTION VARNISH

(71) Applicant: Miba Gleitlager Austria GmbH, Laakirchen (AT)

(72) Inventor: Georg LEONARDELLI, Gmunden (AT)

(73) Assignee: Miba Gleitlager Austria GmbH, Laakirchen (AT)

(21) Appl. No.: 17/182,411

(22) Filed: Feb. 23, 2021

(30) Foreign Application Priority Data
Mar. 3, 2020 (AT) A50159/2020

(51) Int. Cl. C09D 5/08; C09D 183/06; C08K 5/3447; C08K 3/32; F16C 33/20

(52) U.S. Cl. CPC C09D 5/086; C09D 183/06; C08K 5/3447; C08K 2003/324; F16C 33/203; F16C 33/201; C08K 3/32

(57) ABSTRACT

An anti-friction varnish includes at least one organic binding agent, at least one solid lubricant and at least one bonding agent for improving the adhesion of a polymeric sliding layer, which may be produced from the anti-friction varnish, on a substrate, wherein the at least one bonding agent includes a ligand, which connects the bonding agent to the organic binding agent or to the substrate.

### CROSS REFERENCE TO RELATED APPLICATIONS

Applicant claims priority under 35 U.S.C. § 119 of Austrian Application No. A50159/2020 filed Mar. 3, 2020, the disclosure of which is incorporated by reference.

### BACKGROUND OF THE INVENTION

### 1. Field of the Invention

The invention relates to an anti-friction varnish comprising at least one organic binding agent, at least one solid lubricant and at least one bonding agent for improving the adhesion of a polymeric sliding layer that can be produced from the anti-friction varnish on a substrate.

The invention further relates to a sliding bearing element comprising at least one metal layer on which a polymeric sliding layer is arranged.

The invention also relates to a method for producing a sliding bearing element comprising the steps: providing a substrate having at least one metal layer; applying an anti-friction varnish with at least one organic binding agent and at least one bonding agent to the metal layer; curing the organic binding agent.

The invention further relates to the use of a corrosion inhibitor.

### 2. Description of the Related Art

Multi-layer sliding bearing elements are usually used for the friction-reduced connection of two machine elements, for example for the bearing of rotating components such as shafts. In this context, the use of polymer-based layers in sliding bearings has been sufficiently described in the prior art. For example, a bearing element having a metal support body, a bearing metal layer arranged on top thereof as well as a polymeric layer arranged on top thereof is known from publication EP 1 717 469 A2 tracing back to the applicant. The polymeric layer consists of a polyamide resin, molybdenum disulfide and graphite.

It is further known from the prior art to add a bonding agent to an anti-friction varnish. For example, DD 300 385 A7 describes anti-friction varnishes consisting of air- and/or oven-drying binding agents, fluoropolymer particles, optionally pigments and/or dyes, solvents, wetting agents, with which abrasion-resistant surfaces are obtained which have coatings with low coefficients of friction, high abrasion resistance, high adhesion to the substrate material, anti-adhesive properties and good water resistance, wherein the anti-friction varnishes contain silanes of the general formula R1-Si(OR)3, wherein R1 is an alkenyl, cycloalkenyl, cycloalkenylalkyl or (meth)acryloxyalkyl group and R is an alkyl or alkoxyalkyl group having 1 to 5 C atoms.

### SUMMARY OF THE INVENTION

The invention is based on the object of improving sliding bearing elements provided with anti-friction varnishes in view of the problem of a delamination of the anti-friction varnish layer from the base.

The object of the invention is achieved by the initially mentioned anti-friction varnish in which it is provided that the at least one bonding agent comprises at least one ligand which connects the bonding agent to the organic binding agent or the substrate.

The object of the invention is further achieved by the initially mentioned sliding bearing element which comprises a polymeric sliding bearing element of an anti-friction varnish.

The object of the invention if further achieved by the initially mentioned method, according to which it is provided that an anti-friction varnish according to the invention is applied and the at least one bonding agent is connected to the metal layer and/or to the organic binding agent.

Lastly, the object of the invention is also achieved by the use of a corrosion inhibitor as bonding agent in an anti-friction varnish for a sliding bearing element.

The advantage of this is that with the bonding agent per se, the adhesive strength of the polymeric sliding layer on the substrate can be improved, wherein by the connection of the bonding agent to the substrate or the organic binding agent, the sliding layer produced from the anti-friction varnish can be subjected to a higher mechanical load without there being the risk of a detachment of the sliding layer from the substrate. In this regard, according to the method, it can be provided that the connection of the bonding agent to the substrate and/or the polymeric binding agent can be established during curing of the binding agent, which can facilitate the production of the polymeric sliding layer of the anti-friction varnish, since no additional method steps for connecting the bonding agent to the substrate or the polymeric binding agent are required. Moreover, it can be provided that a corrosion inhibitor is used as bonding agent, wherein the additional functionality “bonding agent” can already be brought into the anti-friction varnish with the functionality “corrosion protection”. The sliding bearing element thus, besides the improved corrosion resistance, can also have an improved adhesive strength on the substrate.

To further improve the aforementioned effect, according to an embodiment variant of the invention it can be provided that the anti-friction varnish comprises both a bonding agent with a ligand which connects the bonding agent to the substrate and a bonding agent with a ligand which connects the bonding agent to the organic binding agent.

According to a further embodiment variant of the invention, it can be provided that the bonding agent comprises both the ligand which connects the bonding agent to the substrate and the ligand which connects the bonding agent to the organic binding agent. Thus, via the bonding agent, a type of bridge formation is provided, since the polymeric sliding layer can be better bonded to the substrate by means of the bonding agent. Thereby, at least parts of the aforementioned effects can be further improved.

According to another embodiment variant of the invention, ligands which are selected from a group consisting of azoles, silanes, thiols, orthophosphates, thiols, phosphonic acids, sulfonic acids have shown to be particularly suitable to achieve the aforementioned effects regarding the connection to the substrate.

According to another embodiment variant of the invention, ligands which are selected from a group consisting of imides, amides, thioamides, thiocarbamides, carboxyls, silanes, siloxanes, amines have shown to be particularly suitable to achieve the aforementioned effects regarding the connection to the polymer.

According to a further embodiment variant of the invention, it can be provided that
the azole is selected from a group consisting of dimercaptothiazole, tolyltriazole, 1,3,4-thiazole, benzotriazoles, in particular benzotriazole-5-carboxylic acid, mercaptobenzotriazoles, imidazoles, in particular benzimidazoles, and/or
the silane is an epoxytrimethoxysilane, and/or
the orthophosphate is trisodium phosphate.

According to another embodiment variant of the invention, it can be provided that the proportion of the bonding agent in the overall composition of the polymeric sliding layer is between 0.2 wt. % and 5 wt. %. In case of a proportion of less than 0.2 wt. % no essential improvement of the adhesive strength of the polymeric sliding layer on the metal substrate could be observed. In case of a proportion of the bonding agent of more than 5 wt. %, the proportions of the remaining components of the anti-friction layer are very reduced, which causes the further desired properties of the anti-friction varnish, such as the coherence of the layer itself, i.e. the embedding of the solid lubricant particles, or the reduction of the coefficient of friction, etc., to suffer too much.

In the preferred embodiment variant of the invention, the organic binding agent is a polyimide, a polyamideimide, a polyester, a phenolic resin, in particular where the bonding agents are formed according to one of the aforementioned embodiment variants.

According to an embodiment variant of the sliding bearing element, it can be provided that the metal layer consists of an alloy containing copper, since it was observed that the aforementioned anti-friction varnish in particular shows the aforementioned effects in copper-containing metal layers.

It is particularly preferred for the polymeric sliding layer to be arranged on a sliding bearing element in which all layers are free of lead, in particular when the bonding agent also acts as a corrosion inhibitor.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a multi-layer sliding bearing element in a lateral view.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

Indications regarding the alloy compositions are to be understood such that these include usual impurities as occur in raw material used on an industrial scale. However, in the context of the invention, there is the possibility that pure metals and/or purest metals are used.

Moreover, the indications on compositions are to be understood in wt. % if nothing else is explicitly indicated.

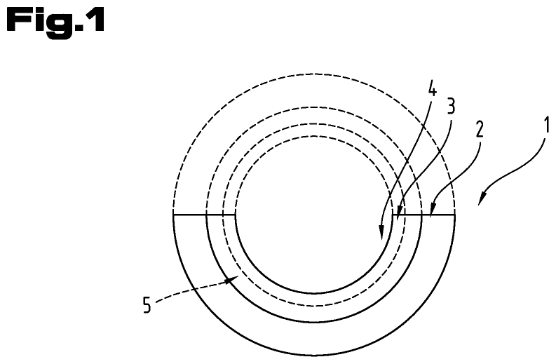

FIG. 1 shows a sliding bearing element 1 (which can also be referred to as multi-layer sliding bearing element) in the form of a sliding bearing half shell. What is shown is a two-layer variant of the sliding bearing element 1 consisting of a support layer 2 and a sliding layer 3, which is arranged on a front side 4 (radially inner side), that can be faced towards a component to be borne, of the sliding bearing element 1.

Where applicable, a bearing metal layer 5 can be arranged between the sliding layer 3 and the support layer 2, as is adumbrated in dashed lines in FIG. 1.

The principle structure of such sliding bearing elements 1, as are used for example in internal combustion engines, is known from the prior art, so that further explanations can be dispensed with. However, it should be noted that further layers can be arranged, i.e. for example a bonding agent layer and/or a diffusion barrier layer, etc. between the metal bearing layer 5 and the support metal layer.

In the context of the invention, the multi-layer sliding bearing 1 can also be designed differently, for example as a bearing bush, as is adumbrated in dashed lines in FIG. 1. Likewise, designs such as thrust rings, axially extending sliding shoes or the like are possible.

The sliding layer 3 is preferably arranged on a metal layer of the sliding bearing element 1 which contains copper. In particular, the sliding layer is arranged directly on this layer.

The expression “contains copper” in this regard comprises alloys that contain copper as an alloy component, copper base alloys in which copper forms the matrix in which other phases of the copper base alloy are enclosed or arranged, and layers formed from copper alone. However, the sliding layer 3 is preferably arranged (directly) on a copper base alloy and/or connected thereto.

Furthermore, it is preferred for all layers of the sliding bearing element 1 to be formed free of lead. In this context, “free of lead” means that these layer preferably do not contain any lead. However, at least one of the layers can comprise a maximum proportion of lead in the amount of the usual impurities that are usually present in the elements used to produce the respective layer of the sliding bearing element 1. This proportion of lead can for example originate from the recycling of metals. Usually, said proportion of lead in the respective layer of the sliding bearing element 1 is not higher than 0.1 wt. %. In any case, no extra lead is added as an alloy component in the preferred embodiment variant of the sliding bearing element 1.

The support layer 2 may consist of steel, however, can also consist of another material providing the sliding bearing element 1 with the required structural strength. Such materials are known from the prior art. For example, the support layer 2 may be made of a copper bronze.

If the sliding layer 3 is not arranged directly on the support layer 3, the bearing metal layer 5 can be a copper-containing layer on which the sliding layer 3 is arranged.

Moreover, it is possible that a further sliding layer is arranged between the bearing metal layer 5 and the sliding layer 3. This further sliding layer then is a metal sliding layer which preferably is a copper-containing layer. In this case, the sliding layer 3 arranged on the further sliding layer can (also) have the function of a running-in layer.

The alloys and/or materials known from the relevant prior art may (also) be used for the bearing metal layer 5 as well as for the intermediate layers, and corresponding reference is made thereto in this regard.

The sliding layer 3 is a polymer-based layer which is formed of an anti-friction varnish.

The anti-friction varnish can be in solid form or preferably in liquid form and can be applied to the respective substrate. The methods for application are known and does do not have to be addressed in further detail. The anti-friction varnish may for example be spread, sprayed, dipped on, etc.

The anti-friction varnish comprises at least one organic binding agent, at least one solid lubricant and at least one bonding agent for improving the adhesion of the polymeric sliding layer 3 that can be produced from the anti-friction varnish on a substrate. In addition, the anti-friction varnish may also comprise at least one further component, such as hard particles, metal particles, at least one solvent, colorants, etc.

The organic binding agent or polymeric base is preferably a polyimide, a polyamideimide, a polyester, a phenolic resin. However, other organic binding agents on an organic basis may also be used, such as epoxide or polybenzimidazole (PBI). Likewise, mixtures of at least two of the mentioned polymers as well as modifications of these polymers can also be used as organic binding agent.

In the anti-friction varnish, the organic binding agent is present in uncured (and preferably dissolved) form as a monomer or generally as precursor(s) of the polymer. During curing or by curing the polymer is formed.

The polyimide polymer may for example be selected from a group comprising or consisting of polyimide (PI), polysuccinimide (PSI), polybismaleinimide (PBMI), polybenzimidazole (PBI), polyoxadiazobenzimidazole (PBO), and polyimide sulfone (PISO), and mixtures thereof.

Preferably, the polymer is a polyamideimide. The polyamideimide may comprise at least partially aromatic groups or it may be a fully aromatic polyamideimide.

The proportion of the polymeric binding agent in the polymeric layer that can be produced from the anti-friction varnish, in particular of the sliding layer 3, is preferably selected from a range with a lower limit of 25 wt. % and an upper limit of 50 wt. %, in particular a lower limit of 30 wt. % and an upper limit of 45 wt. %. It is particularly preferred for the proportion of the binding agent in the polymeric layer to amount to 37 wt. %.

At this point, it should be noted that by curing and/or during curing of the anti-friction varnish, the solvent is removed. The composition of the anti-friction varnish can thus differ from the composition of the polymeric layer if the anti-friction varnish contains a solvent. In this case, the solvent proportion in the anti-friction varnish is to be taken into consideration.

In this context, it should be noted that of course all indications regarding the composition of the polymeric layer and/or of the and/or are to be understood such that the sum of the quantitative proportions of all components of the polymeric layer and/or of the and/or must yield 100 wt. %. The polymeric layer and/or the anti-friction varnish can thus also comprise compositions selected from the ranges mentioned in the present description.

The solid lubricant particles can be selected from a group comprising or consisting of graphite, MoS₂, WS₂, Sn, SnS and SnS₂, ZnS, ZnS₂, hexagonal BN, Sn alloys, CF₂, PbF₂, PTFE, etc. Mixtures of two or multiple different solid lubricant particles can be used as well. In principle, these solid lubricants are already known from the prior art to an extent sufficient for this purpose of use.

The overall proportion of the solid lubricant particles in the polymeric layer that can be produced from the anti-friction varnish, in particular of the sliding layer 3, can be selected from a range with a lower limit of 25 wt. % and an upper limit of 60 wt. %, in particular from a range with a lower limit of 40 wt. % and an upper limit of 60 wt. %. It is particularly preferred for the overall proportion of the solid lubricant particles in the polymeric layer to amount to between 50 wt. % and 55 wt. %.

The solid lubricant particles can have a maximum particle size D90 of 40 μm.

In this context, the maximum particle size is understood to be that dimension of a particle which is largest in comparison to other dimensions of the same particle. The maximum dimension can thus also be understood of the diameter of that enclosing sphere which just completely encloses the respective particle.

In particular, the solid lubricant particles can have a particle size distribution (grain size distribution) of D50=3 μm to 15 μm, measured by sieve analysis.

In the preferred embodiment variant, the anti-friction varnish, and thus also the polymeric layer, contains graphite and MoS₂ as solid lubricant particles. In this regard, the proportion of graphite in the polymeric layer can be selected from a range having a lower limit of 0.1 wt. % and an upper limit of 20 wt. %, in particular from a range having a lower limit of 5 wt. % and an upper limit of 15 wt. %. It is particularly preferred for the proportion of graphite in the polymeric layer to amount to 8 wt. %. The MoS₂ forms the remainder of the aforementioned overall proportion of solid lubricants in the polymeric layer.

The polymeric layer and/or the anti-friction varnish may comprise hard particles so as to adapt the hardness of the polymeric layer. These hard particles may be selected from a group comprising or consisting of metal oxide particles, such as CrO₃, Fe₃O₄, ZnO, CdO, Al₂O₃, SiO₂, MnO, TiO₂, mixed oxide particles, such as bismuth vanadate (BiVO4), chromium antimony rutile, clay, talc, aluminum silicates, such as. E.g. mullite, magnesium silicates, such as amosite, antophyllite, chrysotile, carbides, such as SiC, CaC₂, Mo₂C, WC, metal particles, such as. Al, Ag, Sn, Zn, Ag, Ba, bronze, Cd, Co, Cu, In, alloy particles of these metals, metal nitrides, such as Si3N₄, AlN, Fe₃P, metal borides, such as. Fe₂B, Ni₂B, FeB, BaSO₄, chlorinated hydrogen carbonates, fluorides, such as CaF₂, metal oxyfluorides, crocidolite, tremolite, silicides, thiophosphates, such as zinc thiophosphate.

Mixtures of different additives and/or hard substances, for example of two, three, four or more different additives and/or hard substances, may also be used.

The proportion of the hard particles in the polymeric layer can be selected from a range having a lower limit of 1 wt. % and an upper limit of 20 wt. %, in particular from a range having a lower limit of 1 wt. % and an upper limit of 5 wt. %.

The solvent that is optionally present in the anti-friction varnish may be selected from a group comprising and/or consisting of xylene, dimethylformamide, methyl ethyl ketone, gamma butyrolactone, dimethylacetamide, N-methyl-2-pyrrolidone, 1-butylpyrrolidin-2-one, etc. Mixtures of at least two different solvents may be used as well.

The proportion of at least one solvent in the anti-friction varnish may be selected from a range having a lower limit of 50 wt. % and an upper limit of 80 wt. %, in particular from a range having a lower limit of 60 wt. % and an upper limit of 70 wt. %. Preferably, the proportion of the solvent in the anti-friction varnish may amount to 65 wt. %.

The anti-friction varnish (and thus also the polymeric layer) may, however, also comprise further components, such as fibers, metal plates, etc. The proportion of these further components may amount to between 0.1 wt. % and 20 wt. %.

As elucidated above, the anti-friction varnish and thus also the polymeric layer produced therefrom, in particular the sliding layer 3, comprises at least one bonding agent. The bonding agent is/is intended to be connected to the organic, polymeric binding agent or to the (metal) substrate, onto which the anti-friction varnish is applied. In particular, the connection is formed in the manner of a coordinative bond (donor-acceptor bond) with respect to the bond to the polymeric binding agent and with respect to the bond to the substrate. However, other bonds are also possible, such as covalent bonding to the polymeric binding agent. For this purpose, the at least one bonding agent comprises corresponding ligands which will be elucidated in further detail below.

In this context, it should be noted that a ligand may be understood as both a chemical connection per se and a particular chemical group (which may also be referred to as “reactive group”) in the molecule of the bonding agent, which reacts or can react with the binding agent or the substrate. For example, the bond “benzotriazole” may comprise the ligand “carboxylic acid” which established the connection to the polymer. The bonding agent then is benzotriazole-5-carboxylic acid. Likewise, the bond “undecane” may be provided with the ligand thiol as a bonding agent and the ligand carboxyl as a connection to the binding agent, resulting in 11-mercaptoundecanoic acid as an added substance. If the ligand is a reactive group, it may be provided that the carrier molecule which carries the ligand is an organic compound with a molar mass of a maximum of 200 g/mol, preferably a maximum of 150 g/mol in particular a maximum of 100 g/mol. The lower limit of these ranges is preferable 20 g/mol in each case. The carrier molecule may for example be a phenol, an alkane, such as butane, undecane, etc.

According to an embodiment variant of the invention it can be provided that the anti-friction varnish comprises both a bonding agent with a ligand which connects the bonding agent to the substrate and a bonding agent with a ligand which connects this bonding agent to the organic binding agent. Hence, the polymeric layer is on the hand connected to the substrate and on the hand connected to the binding agent (i.e. to the molecules of the binding agent), wherein, however, no continuous connection of the binding agent molecules to the substrate is given.

To achieve this, according to a further embodiment variant of the invention, it may be provided that the bonding agent carries at least two different ligands, wherein one of these ligands bonds with the substrate and the other ligands bonds to the binding agent. Hence, a direct bond of the binding agent to the substrate can be achieved via the bonding agent.

The proportion of the bonding agent (and/or the summary proportion of bonding agents in case of multiple bonding agents) in the overall composition of the polymeric layer produced from the anti-friction varnish (sliding layer 3) preferably amounts to between 0.2 wt. % and 5 wt. %, in particular between 0.5 wt. % and 2.5 wt. %. For example, the proportion of the bonding agent in the overall composition of the polymeric layer may amount to between 1.8 wt. % and 2.2 wt. %. The proportion of the bonding agent in the anti-friction varnish with solvent may be calculated from these values taking into consideration the solvent proportion. For this purpose, the composition of the polymeric layer to be produced from the anti-friction varnish is used as a basis according to the indications in the present description. This composition must result to a summary proportion of 100 wt. % in the first step. Then, the solvent proportion is added on this composition, which reduces the proportion of the individual components of the previously determined composition in the anti-friction varnish with solvent according to the solvent proportion. Since this is known to the person skilled in the art, it does not require further explanation.

According to embodiment variants of the invention, it may be provided that the ligand (i.e. in this case the reactive group), which connects the bonding agent to the substrate, is selected from a group consisting of azoles, silanes, thiols, orthophosphates, thiols, phosphonic acids, sulfonic acids, and/or that the ligand (i.e. also in this case the reactive group), which connects the bonding agent to the polymer, is selected from a group consisting of imides, amides, thioamides, thiocarbamides, carboxyls, silanes, siloxanes, amines, vinyls, methacrylates, epoxides, carbamides, titanates and zirconates.

The azole may be selected from a group comprising or consisting of dimercaptothiazole, tolyltriazole, 1,2,4-thiazole, benzotriazoles, in particular benzotriazole-5-carboxylic acid, mercaptobenzotriazoles, imidazoles, in particular benzimidazoles.

The silane may be an epoxytrimethoxysilane.

The orthophosphate may be trisodium phosphate.

For example, the bonding agent may be 5-amino-1,3,4-thiadiazol-2-thiol and/or 3-aminopropyltriethoxysilane and/or (benzothiazol-2-ylthio)succinyl acid and/or 11-mercaptoundecanoic acid and/or 2-(2H-benzotriazol-2-yl)-4,6-bis-(1-phenylethyl-1-methyl)phenol and/or benzotriazole-5-carboxylic acid and/or epoxytrimethoxysilane and/or 5-amino-5-mercapto-1,3,4-thiazol and/or benzotriazole-1-carboxamide and/or 5-benzotriazole carboxylic acid.

The following Table 1 shows some of the compositions which have been testes in the course of the invention. However, it should be noted that corresponding tests have also been carrier with the further mentioned ligands; however, the representation of these would exceed the scope of the present description.

All of these compositions showed an improvement in adhesion on the bearing test rig with oscillating relative motion and/or under increasing load compared to the same compositions without a bonding agent.

All quantitative proportions are to be understood in wt. %. The indications regarding the composition refer to the composition of the polymeric layer produced from the anti-friction varnish, i.e. without a solvent.

TABLE 1
Compositions of the polymeric layer produced from the anti-friction varnish:

| | | | | | | Hard |
|---|---|---|---|---|---|---|
| | | | | | | material/ |
| Bonding agent | Proportion | Polymer | Share | MoS₂ | Graphite | fibers/metals |
| 5-Amino-1,3,4-thiadiazol-2-thiol | 2.0 | PAI | 50 | 29 | 1 | 18 |
| 3-aminopropyltriethoxysilane | 1.0 | PAI | 43 | 40 | 14 | 2 |
| (benzothiazol-2-ylthio)succinyl acid | 1.0 | PAI | 38 | 44 | 15 | 2 |
| 11-mercaptoundecanoic acid | 1.5 | 75 PAI + | 25 | 38.5 | 20 | 15 |
| | | 25 PI | | | | |
| 2-(2H-benzotriazol-2-yl)-4,6- | 0.5 | PAI | 40 | 49.5 | 10 | |
| bis-(1-phenylethyl-1-methyl)phenol | | | | | | |
| 5-benzimidazole carboxylic acid | 1.5 | 75 PAI + | 40 | 43.5 | 15 | |
| | | 25 PI | | | | |
| epoxytrimethoxysilane | 1.5 | 75 PAI + | 45 | 35.5 | 8 | 10 |
| | | 25 Epoxy | | | | |
| 5-amino-5-mercapto-1,3,4-thiazol | 4.0 | PAI | 35 | 36 | 17 | 8 |
| benzotriazole-5-carboxylic acid | 2.0 | PAI | 39 | 48 | 8 | 3 |
| benzotriazole-1-carboxamide | 3.0 | 75 PAI + | 42 | 38 | 15 | 2 |
| | | 25 PBI | | | | |
| 5-amino-1,3,4-thiadiazol-2-thiol | 0.2 | PAI | 25 | 59 | | 15.8 |
| 5-amino-1,3,4-thiadiazol-2-thiol | 5 | PAI | 50 | 45 | | |
| 5-amino-1,3,4-thiadiazol-2-thiol | 0.2 | PAI | 50 | 25 | 10 | 14.8 |
| 5-Amino-1,3,4-thiadiazol-2-thiol | 5 | PAI | 45 | 60 | | |
| 5-amino-1,3,4-thiadiazol-2-thiol | 0.2 | PAI | 50 | 49 | | 0.8 |
| 5-amino-1,3,4-thiadiazol-2-thiol | 5 | PAI | 25 | 45 | 14 | 11 |
| 5-amino-1,3,4-thiadiazol-2-thiol | 0.2 | PAI | 39.8 | 60 | | |
| 5-amino-1,3,4-thiadiazol-2-thiol | 5 | PAI | 50 | 25 | | 20 |
| 5-amino-1,3,4-thiadiazol-2-thiol | 0.2 | PAI | 42.8 | 35 | 22 | |
| 5-amino-1,3,4-thiadiazol-2-thiol | 5 | PAI | 60 | 12 | 20 | 3 |
| 5-amino-1,3,4-thiadiazol-2-thiol | 0.2 | PAI | 56.8 | 5 | 20 | 18 |
| 5-Amino-1,3,4-thiadiazol-2-thiol | 5 | PAI | 52 | 20 | 5 | 18 |
| 5-amino-1,3,4-thiadiazol-2-thiol | 0.2 | PAI | 37.5 | 52.3 | | 10 |
| 5-amino-1,3,4-thiadiazol-2-thiol | 5 | PAI | 37.5 | 27.5 | 20 | 10 |

To produce a sliding bearing element, a single-layer or multi-layer substrate is provided in a first step. It may be produced using the known methods that are common (in the sliding bearing industry). Subsequently, the anti-friction varnish is applied to said substrate, for example using one of the aforementioned methods. After the application of the bonding agent, it is cured. This may be carried out for example by heat treatment, UV light, infrared radiation etc. The curing of anti-friction varnishes per se is known to the person skilled in the art. With curing, the polymeric layer produced from the anti-friction varnish is bonded to the substrate, in particular a metal layer, and/or to the organic binding agent.

The invention also relates to the use of a corrosion inhibitor as bonding agent in an anti-friction varnish for a sliding bearing element, wherein the corrosion inhibitor is selected from the aforementioned ligands.

The exemplary embodiments show or describe possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

Finally, as a matter of form, it should be noted that for ease of understanding of the sliding bearing element 1, it is not obligatorily depicted to scale.

Although only a few embodiments of the present invention have been shown and described, it is to be understood that many changes and modifications may be made thereunto without departing from the spirit and scope of the invention.

### LIST OF REFERENCE NUMBERS

1 sliding bearing element
2 support layer
3 sliding layer
4 front side
5 bearing metal layer

What is claimed is:

1. An anti-friction varnish comprising at least one organic binding agent, at least one solid lubricant and at least one bonding agent for improving the adhesion of a polymeric sliding layer (3), which may be produced from the anti-friction varnish, on a substrate, wherein the at least one bonding agent comprises a ligand, which connects the bonding agent to the organic binding agent or to the substrate.

2. The anti-friction varnish according to claim 1, wherein the anti-friction varnish comprises both a bonding agent with a ligand which connects the bonding agent to the substrate and a bonding agent with a ligand which connects this bonding agent to the organic binding agent.

3. The anti-friction varnish according to claim 2, wherein the bonding agent comprises both the ligand which connects the bonding agent to the substrate and the ligand which connects the bonding agent to the organic binding agent.

4. The anti-friction varnish according to claim 1, wherein the ligand which connects the bonding agent to the substrate is selected from a group consisting of azoles, silanes, thiols, orthophosphates, thiols, phosphonic acids, sulfonic acids.

5. The anti-friction varnish according to claim 1, wherein the ligand which connects the bonding agent to the polymer is selected from a group consisting of imides, amides, thioamides, thiocarbamides, carboxyls, silanes, and siloxanes, amines.

6. The anti-friction varnish according to claim 4, wherein the azole is selected from a group consisting of dimercaptothiazole, tolyltriazole, 1,3,4-thiazole, benzotriazoles, in particular benzotriazole-5-carboxylic acid, mercaptobenzotriazoles, imidazoles, in particular benzimidazoles.

7. The anti-friction varnish according to claim 4, wherein the silane is an epoxytrimethoxysilane.

8. The anti-friction varnish according to claim 4, wherein the orthophosphate is trisodium phosphate.

9. The anti-friction varnish according to claim 1, wherein the organic binding agent is a polyimide, a polyamideimide, a polyester, a phenolic resin.

10. A sliding bearing element (1) comprising at least one metal layer, on which a polymeric sliding layer (3) is arranged, wherein the polymeric sliding layer (3) is produced from the anti-friction varnish according to claim 1.

11. The sliding bearing element according to claim 10, wherein the proportion of the bonding agent in the overall composition of the polymeric sliding layer amounts to between 0.2 wt. % and 5 wt. %, in particular between 0.5 wt. % and 2.5 wt. %.

12. The sliding bearing element (1) according to claim 10, wherein the metal layer comprises an alloy containing copper.

13. The sliding bearing element (1) according to claim 10, wherein all layers of the sliding bearing element (1) are free of lead.

14. A method for producing a sliding bearing element (1) comprising the steps:
providing a substrate having at least one metal layer;
applying an anti-friction varnish with at least one organic binding agent and at least one bonding agent to the metal layer;
curing the organic binding agent,
wherein as the anti-friction varnish, the anti-friction varnish according to claim 1 is applied and that the at least one bonding agent is connected to the metal layer and/or to the organic binding agent.

15. Use of a corrosion inhibitor as the bonding agent in an anti-friction varnish for a sliding bearing element (1).
